(19) United States
(12) Patent Application Publication
(10) Pub. No.: US 2010/0096877 A1
(43) Pub. Date: Apr. 22, 2010

(54) Decorative attachment for motorcycle windshield

(76) Inventor: William M. Vinson, Pineville, LA (US)

Correspondence Address: LITMAN LAW OFFICES, LTD., POST OFFICE BOX 41200, SOUTH STATION, ARLINGTON, VA, 22204, US

(21) Appl. No.: 12/588,494

(22) Filed: Oct. 16, 2009

Related U.S. Application Data
(60) Provisional application No. 61/136,996, filed on Oct. 21, 2008.

(51) Int. Cl. B62J 17/00

(52) U.S. Cl. 296/78.1

(57) ABSTRACT

The decorative attachment for a motorcycle windshield is an ornamental grill or the like adapted for positioning on or over an existing windshield of a motorcycle. The decorative attachment for a motorcycle windshield includes a frame having opposed first and second surfaces. The first surface has first user-selectable ornamentation formed thereon. A screen is mounted within the frame. The screen also has opposed first and second surfaces. The first surface also has second user-selectable ornamentation formed thereon. The second surface of the frame is secured to the motorcycle windshield through the use of any suitable attachment or fastener.

### CROSS-REFERENCE TO RELATED APPLICATION

This application claims the benefit of U.S. Provisional Patent Application Ser. No. 61/136,996, filed Oct. 21, 2008.

### BACKGROUND OF THE INVENTION

1. Field of the Invention

The present invention relates to ornamentation for motorcycles, and more particularly to a decorative attachment for a motorcycle windshield that provides an ornamental grill or the like adapted for positioning on or over an existing windshield of a motorcycle.

2. Description of the Related Art

Motorcycle enthusiasts are known for accessorizing their motorcycles. For example, many motorcycle owners will “chrome out” their motorcycles by replacing original equipment with chromed parts, or by adding chromed components such as saddlebags, seats, exhaust systems and the like. Others typically use unique paint designs, leather accessories, or decals to customize their motorcycles. Windshields, however, typically do not lend themselves to replacement or ornamentation, and often remain in the same condition as when they were installed in the factory. It would be desirable to allow for customizable ornamentation to be added to a motorcycle windshield. Thus, a decorative attachment for motorcycle windshield solving the aforementioned problems is desired.

### SUMMARY OF THE INVENTION

The decorative attachment for a motorcycle windshield is an ornamental grill or the like which is adapted for positioning on or over an existing windshield of a motorcycle. The decorative attachment for a motorcycle windshield includes a frame having opposed first and second surfaces, with the first surface thereof having first user-selectable ornamentation formed thereon. A screen is mounted within the frame, with the screen also having opposed first and second surfaces. The first surface thereof further includes second user-selectable ornamentation formed thereon. The second surface of the frame is secured to the motorcycle windshield through the use of any suitable attachment or fastener.

These and other features of the present invention will become readily apparent upon further review of the following specification and drawings.

### BRIEF DESCRIPTION OF THE DRAWINGS

FIG. 1 is an environmental, perspective view of a first embodiment of a decorative attachment for a motorcycle windshield according to the present invention.

FIG. 2 is an exploded perspective view of the decorative attachment for a motorcycle windshield of FIG. 1.

FIG. 3 is an exploded rear view of the decorative attachment for a motorcycle windshield of FIG. 1.

FIG. 4 is an exploded perspective view of an alternative embodiment of the decorative attachment for a motorcycle windshield according to the present invention.

FIG. 5 is an exploded perspective view of another alternative embodiment of the decorative attachment for a motorcycle windshield according to the present invention.

FIG. 6 is an exploded perspective view of yet another alternative embodiment of the decorative attachment for a motorcycle windshield according to the present invention.

Similar reference characters denote corresponding features consistently throughout the attached drawings.

### DETAILED DESCRIPTION OF THE PREFERRED EMBODIMENTS

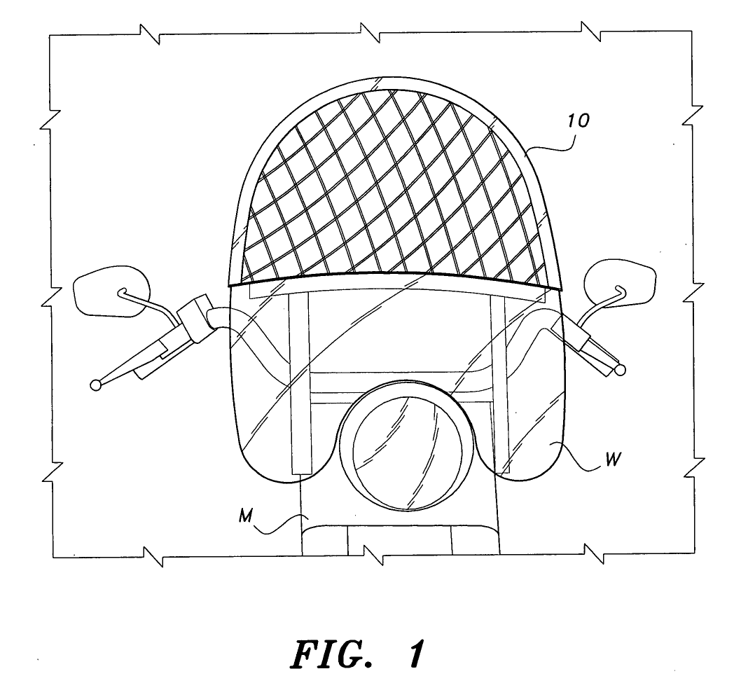

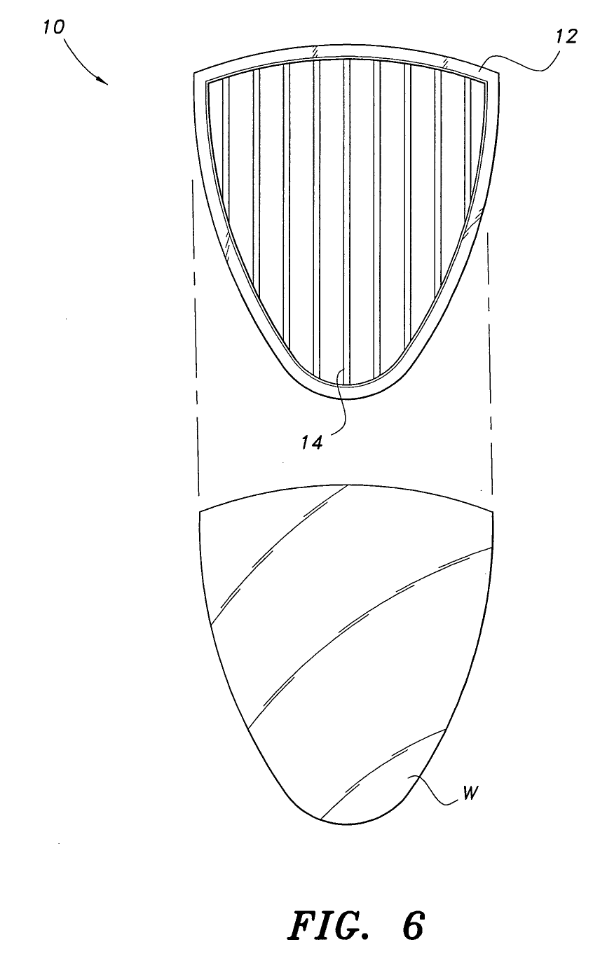

Referring to FIGS. 1-3, a decorative attachment for a motorcycle windshield 10 is shown. As best shown in FIG. 1, the decorative attachment for a motorcycle windshield 10 is an ornamental grill or the like, which is adapted for positioning on or over an existing windshield of a motorcycle. It should be understood that windshield W of motorcycle M is shown for exemplary purposes only. Similarly, the dimensions and configuration of attachment 10 are shown as being compatible with exemplary windshield W. Attachment 10 may be manufactured in a wide variety of sizes and shapes to mate with a wide variety of differing windshields W. FIG. 6 illustrates an alternative windshield configuration than that shown in FIG. 1, with attachment 10 being dimensioned and configured accordingly.

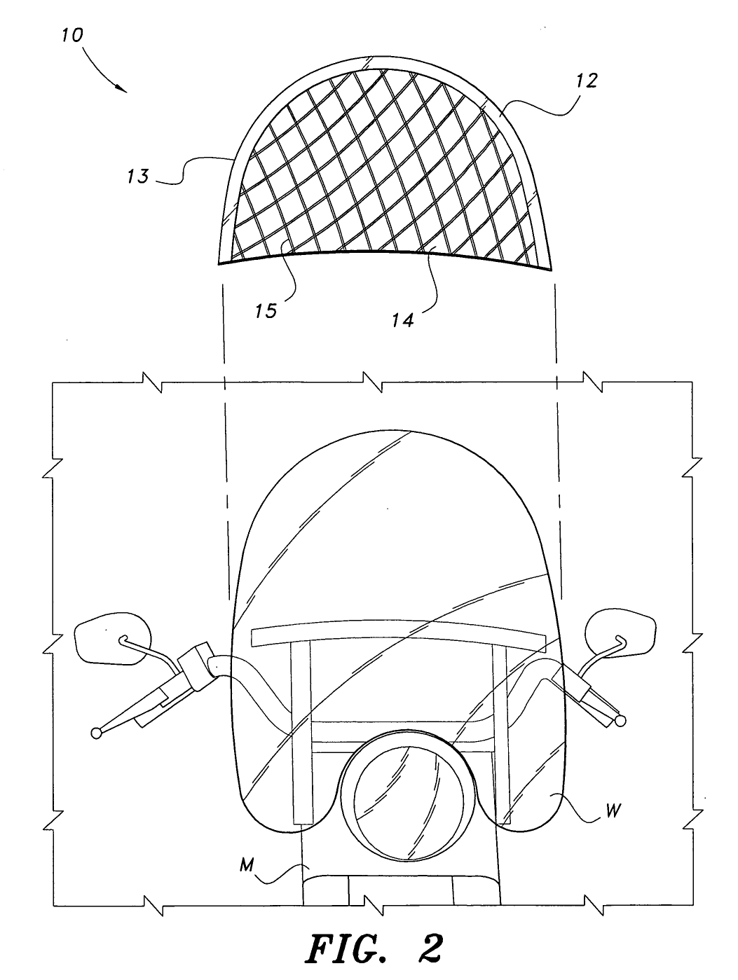

As best shown in FIG. 2, the decorative attachment for a motorcycle windshield 10 includes a frame 12 having opposed first and second surfaces. The first surface has first user-selectable ornamentation 13 formed thereon. It should be understood that the attachment 10 shown in FIGS. 1 and 2 is shown for exemplary purposes only, and that the ornamentation 13 may have any desired design features. Similarly, frame 12 and screen 14 may have any desired size, shape, color, or ornamental appearance. Screen 14 may have openings or apertures formed therethrough, allowing the user to see through screen 14, or may form an opaque surface. FIG. 6 illustrates an attachment 10 having a frame 12 and a screen 14 mounted therein, but with the first, or outer, surfaces of both the frame 12 and screen 14 having a different ornamental appearance than that shown in FIGS. 1 and 2. It should be understood that these design features are shown for exemplary purposes only. Attachment 10 may be formed from chrome or any other desired materials.

Screen 14 is mounted within the frame 12, as shown, with the screen also having opposed first and second surfaces. The first surface also has second user-selectable ornamentation 15 formed thereon. The second surface of the frame 12 is secured to the motorcycle windshield W through the use of any suitable attachment or fastener, with the second surface of the screen 14 being positioned adjacent and contiguous to the outer surface of windshield W.

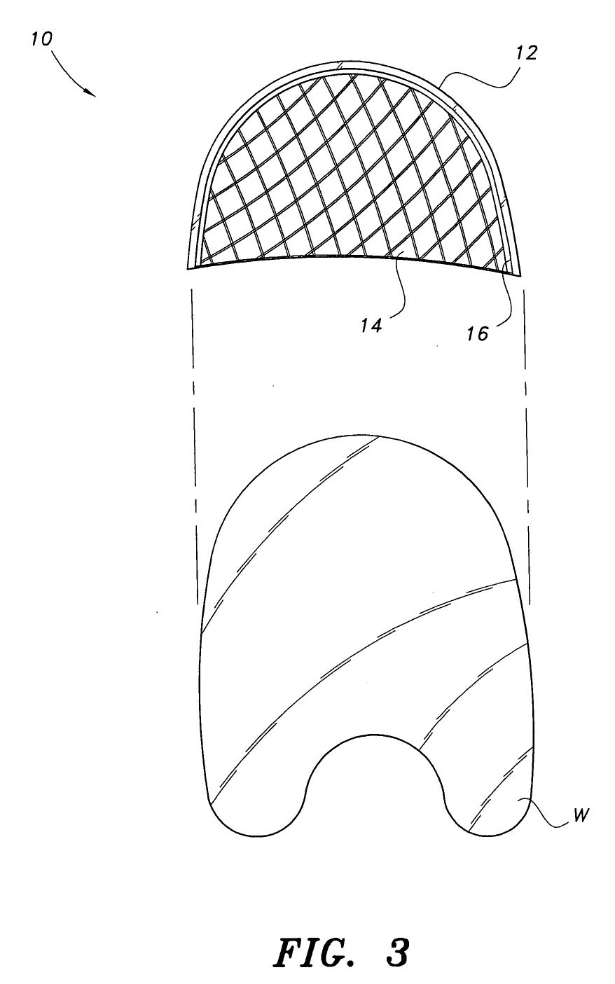

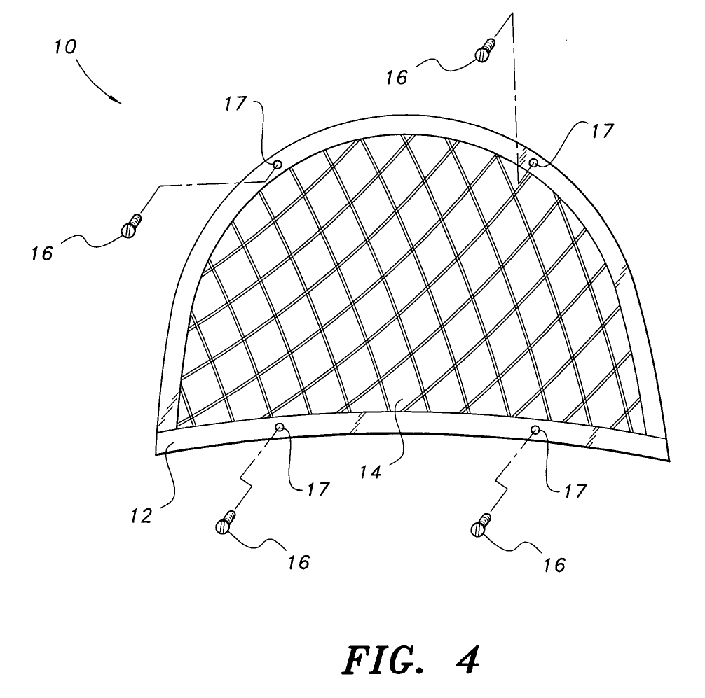

In FIG. 3, the second, or rear, surface of frame 12 is shown as having a peripheral slot 16 formed therein, for receiving the outer edges of windshield W, thus securing the frame 12 to the windshield W. In the alternative embodiment of FIG. 4, frame 12 is provided with a plurality of apertures 17 for receiving threaded screws 16, bolts or the like, for securing the frame 12 to the windshield W. It should be understood that any suitable attachment or fastener, such as adhesive, may be alternatively utilized.

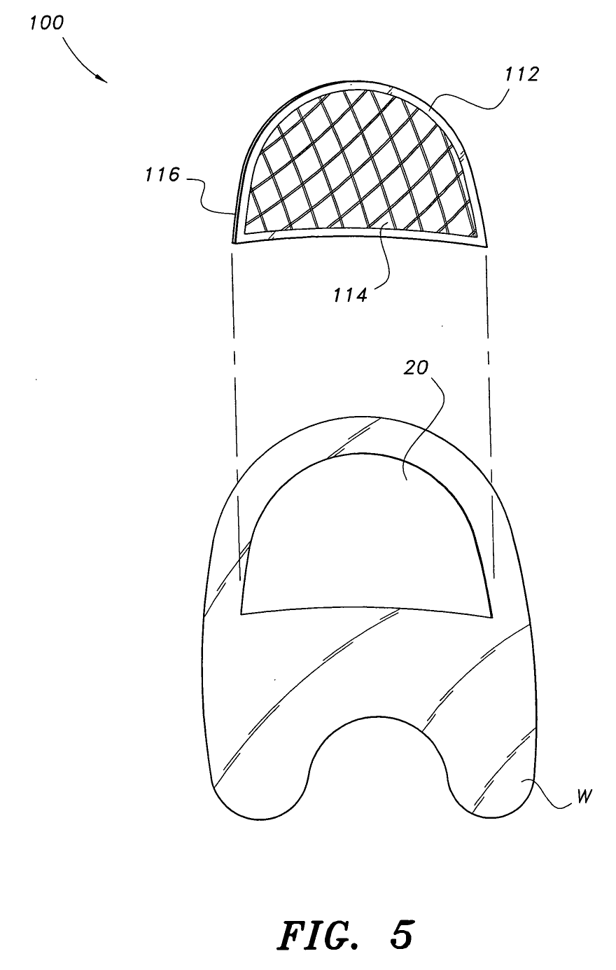

In the alternative embodiment of FIG. 5, windshield W has an opening or cutout region 20 formed therethrough. Rather than placing the attachment over the entire windshield, as in the embodiments of FIGS. 1-4 and 6, the attachment 100 is received within the cutout region 20. Attachment 100 includes a frame 112 with a screen 114 mounted therein. A slot 116 is formed in the peripheral edge of frame 112, as shown, for engaging the border of cutout region 20, thus holding frame 112 therein. Screen 114 may include a plurality of perforations or openings, allowing air to flow therethrough, or may be sealed.

It is to be understood that the present invention is not limited to the embodiments described above, but encompasses any and all embodiments within the scope of the following claims.

I claim:

1. A decorative attachment for a motorcycle windshield, comprising:
a frame having opposed first and second surfaces, the first surface having first user-selectable ornamentation formed thereon;
a screen mounted within the frame, the screen having opposed first and second surfaces, the first surface of the screen having second user-selectable ornamentation formed thereon; and
means for securing the second surface of the frame to a motorcycle windshield.

2. The decorative attachment for a motorcycle windshield as recited in claim 1, wherein the second surface of said frame has an inner peripheral recess formed therein for receiving a peripheral edge of the motorcycle windshield.

3. The decorative attachment for a motorcycle windshield as recited in claim 1, wherein said frame has an outer peripheral recess formed therein adapted for receiving corresponding side edges defining an aperture formed through the motorcycle windshield.

4. The decorative attachment for a motorcycle windshield as recited in claim 1, further comprising a plurality of bolts, said frame having a plurality of openings formed therethrough corresponding to a plurality of openings formed through the motorcycle windshield, the plurality of bolts being adapted for fastening to the pluralities of openings to secure the frame to the motorcycle windshield.

5. A decorative attachment for a motorcycle windshield, comprising:
a frame having opposed first and second surfaces, the first surface having first user-selectable ornamentation formed thereon;
a screen mounted within the frame, the screen having opposed first and second surfaces, the first surface of the screen having second user-selectable ornamentation formed thereon; and
means for securing the frame to a border of an opening formed through a motorcycle windshield.

6. The decorative attachment for a motorcycle windshield as recited in claim 5, wherein said frame has an outer peripheral recess formed therein adapted for receiving corresponding side edges of the border defining the opening formed through the motorcycle windshield.

7. A decorative attachment for a motorcycle windshield, comprising:
a frame having opposed first and second surfaces, the first surface thereof having first user-selectable ornamentation formed thereon, a plurality of openings being formed through the frame;
a screen mounted within the frame, the screen having opposed first and second surfaces, the first surface of the screen having second user-selectable ornamentation formed thereon; and
a plurality of bolts fastened through the openings formed in the frame and adapted for fastening through a corresponding plurality of openings formed through a motorcycle windshield to secure the frame to the motorcycle windshield.
